(19) United States
(12) Patent Application Publication
(10) Pub. No.: US 2002/0036253 A1
(43) Pub. Date: Mar. 28, 2002

(54) Mountable holder for writing implements

(76) Inventor: Gary F. Lake, Bishop, CA (US)

Correspondence Address: GARY F. LAKE, 235 AVENIDA DEL MONTE, BISHOP, CA, 93514, US

(21) Appl. No.: 09/917,484

(22) Filed: Jul. 28, 2001

Related U.S. Application Data
(60) Provisional application No. 60/223,453, filed on Aug. 2, 2000.

(51) Int. Cl. A47G 1/17; F16B 47/00

(52) U.S. Cl. 248/205.3

(57) ABSTRACT

An improved device for holding writing implements that can be adhered onto other surfaces, wherever the user thinks appropriate.The holder device is an elongated base portion with an adhesive for mounting along, and under, one longitudinal edge. The opposite longitudinal edge curls outwardly, upwardly, and circularly, back over itself for approximately 270 degrees, forming three-quarters of an open-ended cylindrically shaped channel, sized to receive and hold elongated writing implements.

### CROSS-REFERENCE TO RELATED APPLICATIONS

This application is entitled to the benefit of Provisional Patent Application Ser. No. 60/223,453, filing date: Aug. 2, 2000.

### BACKGROUND

1. Field of Invention

The invention relates to a device for holding writing implements, specifically a holder that can be adhered onto other things.

2. Description of Prior Art

Often when a pen or pencil is needed, they simply aren't there. This has been an ongoing problem from the caves to the boardrooms. A notebook without a pen is useless, as is a pencil without paper. They are interdependent, with the lack of availability of the writing implement the more common problem. Research into prior-art hasn't shown a device that can be generalized to deal with the many situations where availability of writing implements is needed. And products developed for the current market are lacking in versatility as well. In the past the problem seems for the most part to have been ignored; left to the improvisational instincts of the individual. consider the ball-point pen, slipped into the wire of spiral-bound notebooks, and often lost. Consider a pencil held diagonally on a clipboard, under the clip, on top of the paper, and everything falls out. Consider the coffee cups around the house full of pens and pencils, and not always quite where you would like them to be. And the old standby, the human ear. These improvisations, and many more, are real indications of problem that needs to be solved.

Commercial solutions have dealt mostly with the problem on an individual basis; each specific situation receiving a specific solution. There are zippered pocket-type holders for loose-leaf binders. There are holders mounted on clipboards designed for erasable marker pens. And pocket-protectors. There are loops and sleeves, generally crafted into writing kits of brief cases, generally made of fabrics, plastics, or leather. These iterations often appear to have been designed as an afterthought, with low priority, or low budget, or all three. They tend to fall apart, come unstitched, or stretch out and lose elasticity, all becoming useless.

FIG. 4 of the drawings shows an interesting device found the prior-art search, U.S. Pat. No. 5,820,095 John W. Stone, Oct. 13, 1998. It appears to have been initially designed to hold erasable marker pens, and later generalized to hold pens and pencils. The device performs well holding markers in a lecture-demonstration mode, but not as well with smaller writing implements, having the following problems:

a. The device protrudes obtrusively from whatever it is mounted onto. The highest point of the holder from its base is about 1.4 cm, approximately twice the diameter of the typical writing implement it was designed to hold; higher than the thickness of many notebooks it might be used with. Thickness creates a number of problems in, shelving, stacking, and transporting in brief cases, and others.

b. The height of the device from its base remains the same whether a writing implement is in place, or the device is empty.

c. The four corners of the holding wings are sharp and obtrusive.

d. The device is made from an extruded material that is not as resilient as is needed to hold the variety of sizes as claimed. This lack of resiliency is readily apparent when changing from one size implement to another, especially when changing to a smaller implement.

e. Wooden pencils, mechanical pencils, and ball-point pens are the most common writing implements used today and are not well served by this device, either in the holding function or breadth of application.The above criticisms combine to describe a device that is not as versatile as is needed by the consumer.

### SUMMARY

The invention introduced herein may generally be described as a holder device for writing implements that is: functional, unobtrusive, inexpensive, and can be adhered wherever the user thinks appropriate.

Objects and Advantages

Accordingly, besides the objects and advantages of the holding device described in my above patent, several objects and advantages are:

a. To provide a device that is versatile. Prior-art has not shown a device that can be generalized effectively to deal with the many situations where availability of writing implements is needed, such as: mounted onto the cover materials of various notebooks; or onto clipboards; onto, or close to computers, telephones, message boards, anywhere the user thinks appropriate.

b. To provide a simple, reliable, unobtrusive device easily accommodated in a variety of applications.

c. To provide an inexpensive device, the holder has been designed specifically to be manufactured in various plastics using the extrusion process. Extrusion allows for the forming of the device and the application of the adhesive to be a continuous operation, which is very cost-effective. Extrusion additionally provides the advantage of arbitrary sizing. The length of the holder can be customized to specific applications without requiring further tooling.

d. To provide a device that is easy for the consumer to understand and use. A holder wherein the mounting, and the insertion or removal of the writing implement is obvious, and easy.

e. To provide a holder device wherein a plurality of holders can be arranged in a modular fashion to hold a plurality of writing implements.

f. To provide a device that can be scaled to accommodate writing implements of different sizes.

g. To provide a device that manufacturers can use in conjunction with other products in their product line, as on clipboards for example.

h. To provide a device that can accommodate commercial printing for the purpose of promotional advertising.

i. To provide a device with exemplary holding function that can be mounted almost anywhere.

j. To provide a holder of asymmetric design that improves holding, and distributes the wear-stress over a greater area than do symmetrically designed holder devices.

Further objects and advantages of my invention will become apparent from a consideration of the drawings and ensuing descriptions.

### DRAWING FIGURES

FIG. 1 shows an enlarged end view of the holder device including the adhesive.

FIG. 2 shows a top perspective view of the device with a with a pencil in place.

FIG. 3 shows an enlarged top perspective view of an empty device.

FIG. 4 shows prior-art U.S. Pat. No. 5,820,095 John W. Stone Oct. 13, 1998.

Reference Numerals in Drawing.

| | |
|---|---|
| 10 planar base | 18 channel |
| 12 curl | 20 entry port |
| 13 implement | 22 longitudinal edge |
| 14 distal edge | 24 covered adhesive |
| 16 gap | 26 lateral edge |

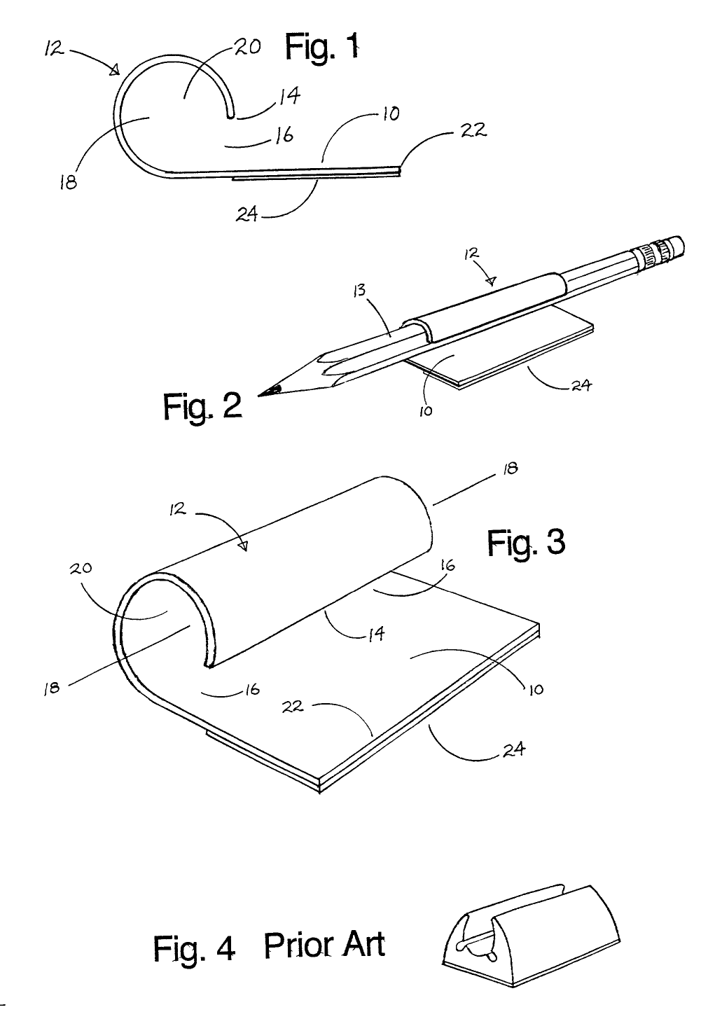

Description—FIGS. 1, 2, and 3—Preferred Embodiment

A preferred embodiment of the holder device is illustrated in FIG. 1 end view, FIG. 2 top perspective view with pencil inserted, and FIG. 3 an enlarged top perspective view without writing implement. FIG. 2 shows generally how the preferred embodiment would appear with a writing implement in place. The holder is approximately 5 cm to 7 cm long, approximately 2 cm wide, and extends at its highest point about 1 cm perpendicularly above the surface mounted onto. The device is approximately 0.5 mm to 0.8 mm thick.

The holder is a one part device, a single piece of extruded plastic that wraps concentrically around a curl 12 area that will hold a writing implement 13, and transitions into a planar base 10, creating sufficient space for a covered adhesive 24, on the underside.Curl 12 starts as a distal edge 14 approximately even with the axial center of the curl 12. Curl 12 loops concentrically for approximately 270 degrees defining a channel 18, cylindrically shaped, within curl 12, which will confine the writing implement. Curl 12 then continues as a planar base 10, ending as a longitudinal edge 22. The lateral width of planar base 10 is approximately 1.5 cm, a sufficient space for adhesive 24. An entry port 20 is located at each end of channel 18. Each entry port 20 is part of a lateral edge 26 defining the arbitrary length of the holding device. As best shown in FIG. 1, a gap 16 is the opening between the distal edge 14 and planar base 10, operative to the necessary flexibility of curl 12.

As best shown in FIG. 3, the holder is made from a thin, extruded plastic and is described in the following way: A thin material with lateral edges 26 lead perpendicularly away from a random length longitudinal edge 22, leaving sufficient space for an adhesive 24 on the underside of about 1.5 cm. At this point the lateral edges curve upwardly and circularly into entry ports 20. Entry ports 20 proceed concentrically for approximately 270 degrees, and terminate as they are connected by distal edge 14. The shaped plastic material between the entry ports is curl 12, and surrounds channel 18, which in turn surrounds implement 13. Channel 18 is smaller in diameter than the implements it will hold. Gap 16 is the open space between distal edge 14 and planar base 10 directly below distal edge. The opening of Gap 16 is equal to about 90 degrees of the circle of channel 18.

An alternative embodiment adds a second curl 12, in a mirrored manner, to longitudinal edge 22. Thus modifying the device to hold two writing implements using the same covered adhesive 24.

Operation—FIGS. 1, 2, and 3

The holder for writing implements best shown in FIG. 1 must first be adhered to something, for example a notebook, not shown. The user should first insert a pen or pencil into the holder and decide on the exact placement on the notebook. Then remove the protective covering from the adhesive, reposition the device and rub it down thoroughly; the device is ready for use. The pen or pencil may be removed in two ways: Firstly, by sliding the implement out through either entry port 20 along the longitudinal axis of channel 18. Secondly, by grasping the implement at either end, and pivoting it against the opposite entry port 20 while maintaining contact with planer base 10.

The device is a thin piece of rectangularly shaped plastic, planar at one end to carry the adhesive for mounting on the underside, and curled cylindrically upward at the other end to carry a writing implement within. Planar base 10 provides a platform for a covered adhesive 24 operative to mounting the device onto other things. Planar base 10 additionally provides a platform from which the holding portion extend into a curl 12. Curl 12 comprising: a mirrored pair of entry ports 20, channel 18, and distal edge 14, all function together to confine and squeeze implement 13. Entry ports 20 located at both ends of the curl provide openings for inserting and removing implement 13. A gap 16 is the opening between the distal edge of the curl and the planar base directly below. Gap 16 serves the flexing of the curl, and one of the methods for removing the implement from the holder.

As best shown in FIG. 1 the empty curl 12 extends concentrically for about 270 degrees upon leaving the planar base, and terminates approximately even with its axial center. When an implement is inserted into channel 18 the curl expands to accommodate the larger diameter. The curl reacts with a constricting force distributed over its 270 degrees, and is the essence of the holding function. The squeezing power of curl 12 is determined by the resiliency, and the thickness, of the material extruded. Styrenes has proven generally effective; other plastics may be desirable in certain applications.

Conclusions, Ramifications, and Scope

Thus the reader will see that the invention described herein proyides a device for holding writing implements that is easy to use, reliable, and highly versatile in its application, a device that anyone who writes could find useful. While my above description contains two embodiments and many specifications, these should not be construed as limitations on the scope of the invention, but rather as exemplifications of the two embodiments thereof. Many other variations are possible. For example:

a. A plurality of the holders can be arranged in a modular fashion to hold a plurality of writing implements.

b. One of the advantages of extrusion is that it allows the device to be easily merchandised in different lengths; some application requiring a different balance between security and accessibility.

c. A variation of the holder could be merchandised in long lengths with the curl precut semi-circularly for the first 180 degrees of the 270 degrees of the curl. The cuts would be evenly spaced, about 2 cm apart, and repeated over the length of the device. This modular approach would allow the user to select the amount of holding power considered appropriate to the application.

d. Using the modular approach described in c. above: three, four, or more of the the short modular devices could be adhered alternately. This configuration would look much like an open hinge, the writing implement being the hinge pin. The curl would loop over the writing implement from both sides and provide the maximum holding potential inherent in the device. The implement would be removed by sliding it out of either end of the curl.

e. In some application it may be advantageous to merchandise the holder device with the adhesive on the side opposite from that of the preferred embodiment.

f. Color may be introduced into the plastic body material that can be decorative or informational.

g. Modify the holder to hold other implements, instruments, tools, or objects of like shape.

h. Modify the holder to accommodate two writing implements using the same adhesive by adding a second mirrored curl.

i. Enlarge the planar base thus increasing promotional advertising potential.

j Modify the base portion to accept a clip device rather than the adhesive, or design a clip Device to accept the holder using the adhesive. Thus a transferable device.

Thus the scope of the invention should be determined by the appended claims and their legal equivalents, rather than by the examples given.

I claim:

1. A holder device for writing implements, asymmetrical in design, that can be adhered onto other surfaces, comprising:
a. a planar base material of appropriate length, width, and thickness, rectangularly shaped, with a covered adhesive on the underside, said covered adhesive operative to mounting said holder onto other surfaces,
b. a channel, cylindrically shaped, is formed upwardly and circularly from a longitudinal edge of said planar base, curling back over said planar base terminating as a distal edge, approximately three-quarters of an open ended cylinder, sized to receive and hold writing implements, whereby said holding devices can be adhered to wherever the user thinks appropriate.

2. The holder of claim 1 wherein said channel is the interior portion of a curl shape, said curl being means for holding described as approximately 270 degrees of an open ended cylinder sized to hold writing implements, an entry port terminates each open end of said can operative to inserting a writing implement therein, said curl is part of said planar base material at its inception, and ends as a distal edge over said planar base a distance approximately equal to the radius of said curl, leaving a gap of approximately 90 degrees of said curl, said entry ports working with said gap combine to provide flexibility for said curl material, whereby curl constricts to squeeze and hold writing implements placed therein.

3. The holder of claim 1 wherein said planar base is a platform that supports said curl means for holding, and said covered adhesive means for mounting onto other surfaces, said planar base of the preferred embodiment measuring approximately 0.05 mm to 0.7 mm thick, 1.7 cm wide, and 6 cm long, whereby said planar base is operative to adhere said holder to other surfaces.

4. The holder of claim 1 wherein said covered adhesive is located on the underside of said planar base which is the side opposite from said curl, said covered adhesive located along a longitudinal edge farthest from said curl, said adhesive matching said planar base in length, the width of said adhesive equal to the distance from a point directly under said distal edge outward to said longitudinal edge approximately 1.25 cm, said adhesive covered by a protective material to be removed prior to mounting, whereby said covered adhesive is sized and protected for mounting said holder device onto other surfaces.

5. The holder of claim 1 wherein said entry ports are the two terminal ends of said curl, said entry ports curl concentrically and vertically from said distal edge into said planar body along the lateral edges of said planar body, whereby providing a logical point of entry for the writing implement, whereby said curl may expand and constrict when a writing implement is inserted within, or withdrawn.

6. The holder of claim 1 wherein said curl ends as said distal edge leaving a gap opening between said distal edge and said planar base directly under said distal edge, said gap in conjunction with said entry ports operative to the flexing of said curl, said gap providing an optional exit area for removing the writing implement, whereby curl may expand and constrict freely, and an implement may be removed by pivoting one end of the implement, planar to the base, against the opposite entry port until released.

7. The holder of claim 1 wherein the unique asymmetric design of said curl provides, for a wide distribution of the flexing stress on said curl, whereby providing a long wearing holder.

8. The holder of claim 1 wherein the unique asymmetric design of said curl loops over and surrounds said channel for 270 degrees, whereby providing a high degree of security for the implement held within.

9. The holder of claim 1 wherein said covered adhesive is on the opposite side from where it is on the preferred embodiment of claim 1, whereby better serving certain applications.

10. The holder of claim 1 wherein said covered adhesive is provided separately from said planar base and covered on both sides, whereby the consumer is given the choice of where to place the adhesive.

11. The holder of claim 1 further including a second said curl added to said planar base along said longitudinal edge opposite said curl in mirrored fashion, two said curls using one said planar base and said covered adhesive, whereby two writing implements can be held therein.

12. The holder of claim 1 wherein said holder is manufactured using the extrusion process allowing an unlimited variety of lengths to be offered without further tooling, whereby costs can be held down.

13. The holder of claim 1 wherein said planar base is enlarged, whereby providing more space for promotional advertising.

14. The holder of claim 1 wherein a variety of sizes of said holder are created to hold other implements, instruments, tools, or objects of similar shape, whereby the holding system becomes more versatile.

15. The holder of claim 1 wherein said distal edge terminates at a distance above said planar base approximately equal to the radius of said channel, whereby said distance operative to the sideways, pivoting removal of the writing implement.

16. The holder of claim 1 further including said distal edge continuing concentrically, terminating said curl at 360 degrees, whereby increasing the security of any implement held therein.

17. The holder of claim 1 further including a thin slot cut through the outward half of said curl perpendicular to the axis of said curl and said planar base, said slot to appear repeatedly along an extended said holder extrusion, said thin slots spaced approximately 1 cm to 2 cm apart, said slots indicate where single or multiple units may be cut off with common scissors and used in modular fashion, whereby consumers may tailor the holder to the particular application.

18. The holder of claim 17 wherein said holders used in modular fashion may be adhered alternately, said curls looping over said channel from opposite sides, looking much like an open hinge, the writing implement being the hinge pin, whereby offering significantly enhanced holding.

19. A device for holding writing implements that in conjunction with an adhesive can be mounted onto other appropriate surfaces, comprising:
a. a single piece device of flat, hard, and resilient extruded plastic, rectangular in shape, having a pair of longitudinal edges and a pair of lateral edges,
b. a planar base portion along one said longitudinal edge, and between said lateral edges, that functions as a platform for a covered adhesive on the underside of said planar base, also functioning as a platform from which a curl portion extends,
c. said curl beginning at said longitudinal edge farthest from said adhesive, extending away, upward, circularly, and back over itself for approximately 270 degrees of said curl, ending as a distal edge, leaving a gap opening between said distal edge and said planar base equal to 90 degrees of said curl, said curl open at both ends as a pair of entry ports, said entry ports connected and parallel with said lateral edges, said gap and said entry ports operative to the flexibility of said curl, said curl forming within itself a channel that is three quarters of an open ended cylinder, operative to accepting and holding a writing implement within, whereby the holder device can be mounted to other things, wherever the user thinks appropriate.
